(19) United States
(12) Patent Application Publication
(10) Pub. No.: US 2026/0349903 A1
(43) Pub. Date: Nov. 5, 2026

(54) SERVER LOG COLLECTION METHOD, APPARATUS, COMMUNICATION DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Yan QU, Suzhou, Jiangsu (CN); Xiubo ZHANG, Suzhou, Jiangsu (CN); Xiangyu WANG, Suzhou, Jiangsu (CN)

(21) Appl. No.: 19/116,273

(22) PCT Filed: Aug. 19, 2024
(86) PCT No.: PCT/CN2024/113134

§ 371 Date: Mar. 27, 2025

(30) Foreign Application Priority Data
Oct. 17, 2023 (CN) 202311345542.8

(51) Int. Cl. G06F 11/34; G06F 13/40; G06F 13/42

(52) U.S. Cl. CPC G06F 11/3476; G06F 11/349; G06F 13/4068; G06F 13/4282; G06F 2213/0042; G06F 2213/24

(57) ABSTRACT

The embodiments of the present disclosure provides a server log collection method, an apparatus, a communication device and a storage medium, and the method includes the following steps: determining that an external device accesses a server log collection system by a first USB controller, wherein the server log collection system includes an embedded controller and a baseboard management controller, and the embedded controller and the baseboard management controller are in communication connection through a USB bus; sending a USB interrupt to the second USB controller, so that the baseboard management controller triggers the log collection process according to the USB interrupt, and collects the log information into the shared memory.

### CROSS-REFERENCE TO RELATED APPLICATION

The present disclosure claims the priority of Chinese patent application filed in CNIPA on Oct. 17, 2023, with the application number of 202311345542.8 and the application name of “SERVER LOG COLLECTION METHOD, APPARATUS, COMMUNICATION DEVICE, AND STORAGE MEDIUM”, the entire contents of which are incorporated into the present disclosure by reference.

### FIELD

The present disclosure relates to the technical field of log collection, in particular to a server log collection method, apparatus, communication device and storage medium.

### BACKGROUND

In the field of servers, the Type-C interface (a form factor standard for Universal Serial Bus interfaces) is a new type of USB (Universal Serial Bus) interface that connects external devices to server systems. It offers multiple functionalities, including power delivery, high-speed data transfer, and video transmission. For server data transfer, the Type-C interface provides high-speed data transfer capabilities. The Baseboard Management Controller (BMC) can connect to storage devices on the server via the Type-C interface, enabling rapid data transfer and backup.

At present, the mobile phone connection server can access the baseboard management controller by the Type-C interface, and the baseboard management controller can enable manual data copying to the mobile phone. For example, log information from the baseboard management controller can be downloaded and copied using third-party software, thereby obtaining the log data.

However, the above method of log transmission only by the baseboard management controller and external devices will integrate all the log transmission acquisition modules into the baseboard management controller. Because the baseboard management controller needs to be responsible for a lot of other work in the normal operation of the system, the baseboard management controller is overloaded and the transmission rate with external devices is reduced.

### SUMMARY

The purpose of some embodiments of the present disclosure is to provide a server log collection method, apparatus, communication device and storage medium, to solve the technical problem that in the prior art, judging the location only by single frame data will lead to insufficient robustness, and even the system cannot work normally. The specific technical solution is as follows.

The purpose of some embodiments of the present disclosure is to provide a server log collection method, device, communication device and storage medium, to solve the technical problems that the load of the baseboard management controller is too high and the transmission rate with the external device is reduced only by the baseboard management controller and the external device in the prior art. The specific technical solution is as follows.

On a first aspect of the embodiments of the present disclosure, a server log collection method is provided firstly, which is applied to an embedded controller, including:
determining that an external device accesses a server log collection system by a first USB controller, wherein the server log collection system includes an embedded controller and a baseboard management controller, the embedded controller and the baseboard management controller are in communication connection through a USB bus, the embedded controller includes a first USB controller, and the baseboard management controller includes a second USB controller;
sending a USB interrupt to the second USB controller to enable the baseboard management controller to trigger a log collection process according to the USB interrupt, and collecting log information into a shared memory, wherein the shared memory is used to store the log information fed back by the baseboard management controller and the embedded controller, and the external device reads the log information by the baseboard management controller.

Optionally, before a step of determining that the external device accesses the server log collection system by the first USB controller, the method includes:
in response to detecting that the server log collection system is in a power-on state and the external device accesses the server log collection system, setting the first USB controller as a master control state, and the master control state is used to control the external device.

Optionally, after a step of sending the USB interrupt to the second USB controller to enable the baseboard management controller to triggers the log collection process according to the USB interrupt and collecting the log information into the shared memory, the method includes:
receiving a data analysis and storage instruction sent by the baseboard management controller through a USB channel;
performing data analysis and classified storage on the log information according to the data analysis and storage instruction, and respectively obtaining a data analysis result and a classified storage result.

Optionally, performing data analysis and classified storage on the log information according to the data analysis and storage instruction to obtain the data analysis result and the classified storage result respectively includes:
retrieving the log information in the shared memory according to the data analysis instruction;
classifying and storing the log information to obtain the classified storage result, and
performing data analysis on the log information to obtain the data analysis result.

Optionally, classifying and storing the log information to obtain the classified storage result includes:
classifying and storing the log information based on a preset type by a preset clustering analysis algorithm to obtain a first classified storage result, wherein the preset type includes at least one of component, temperature, CPU and memory.

Optionally, classifying and storing the log information to obtain the classified storage result includes:
classifying and storing the log information based on alarm levels by a preset language processing algorithm to obtain a second classified storage result, wherein the alarm levels include a serious alarm and a non-serious alarm.

Optionally, performing data analysis on the log information to obtain the data analysis result includes:
constructing an anomaly detection model for the log information by a preset anomaly detection algorithm;
performing anomaly information detection on the log information by the anomaly detection model to obtain anomaly log information.

Optionally, after a step of performing data analysis and classified storage on the log information according to the data analysis and storage instruction to obtain a data analysis result and a classified storage result respectively, the method includes:
updating the data analysis result and the classified storage result to the shared memory;
sending log storage completion information to the baseboard management controller through the USB channel.

Optionally, after a step of sending the log storage completion information to the baseboard management controller through the USB channel, the method includes:
in response to detecting that the first USB controller is in the master control state, continuing to monitor whether there is a new external device by the second USB controller.

On another aspect of the embodiments of the present disclosure, another server log collection method is provided, which is applied to a baseboard management controller, including:
receiving a USB interrupt sent by an embedded controller by a second USB controller, wherein the USB interrupt is generated when the embedded controller determines that an external device accesses a server log collection system by a first USB controller, and the server log collection system includes an embedded controller and a baseboard management controller, the embedded controller and the baseboard management controller are in communication connection through a USB bus, wherein the embedded controller includes a first USB controller and the baseboard management controller includes a second USB controller;
triggering a log collection process according to the USB interrupt, and collecting log information into a shared memory, wherein the shared memory is used to store the log information fed back by the baseboard management controller and the embedded controller, and the external device reads the log information by the baseboard management controller.

Optionally, triggering the log collection process according to the USB interrupt and collecting the log information into the shared memory includes:
calling a preset interrupt handler in the embedded controller and clearing a USB interrupt flag bit;
triggering the log collection process according to the USB interrupt flag bit, and collecting the log information into the shared memory.

Optionally, after a step of triggering the log collection process according to the USB interrupt and collecting the log information into the shared memory, the method further includes:
sending a data analysis and storage instruction to the embedded controller through a USB channel, so that the embedded controller performs data analysis and classified storage on the log information according to the data analysis and storage instruction, and obtains a data analysis result and a classified storage result respectively.

Optionally, after a step of sending a data analysis and storage instruction to the embedded controller through a USB channel, so that the embedded controller performs data analysis and classified storage on the log information according to the data analysis and storage instruction, and obtains a data analysis result and a classified storage result respectively, the method includes:
receiving log storage completion information sent by the embedded controller through the USB channel;
switching the second USB controller to a master control state and switching the first USB controller to a slave control state;
sending the log information to the external device by the second USB controller.

Optionally, sending the log information to the external device through the second USB controller includes:
copying the data analysis result and the classified storage result to the external device by the second USB controller.

Optionally, after a step of sending the log information to the external device through the second USB controller, the method includes:
in response to detecting that storage of the log information in the external device is completed, switching the second USB controller to the slave control state, and switching the first USB controller is to the master control state, so that the embedded controller continues to monitor whether there is a new external device by the second USB controller.

On another aspect of the embodiments of the present disclosure, a server log collection system is provided, wherein the server log collection system includes an embedded controller, a baseboard management controller and a shared memory, the embedded controller and the baseboard management controller are in communication connection through a USB bus;
the embedded controller includes a first USB controller, and the baseboard management controller includes a second USB controller;
the first USB controller is used to determine that an external device accesses to the server log collection system;
the second USB controller is used to receive the USB interrupt sent by the first USB controller, trigger a log collection process according to the USB interrupt, and collect the log information into the shared memory; and
the external device reads the log information by the shared memory.

On another aspect of the embodiments of the present disclosure, a server log collection apparatus is further provided, including:
a determining module, configured to determine that an external device accesses a server log collection system by a first USB controller, wherein the server log collection system includes an embedded controller and a baseboard management controller, the embedded controller and the baseboard management controller are in communication connection through a USB bus, the embedded controller includes a first USB controller, and the baseboard management controller includes a second USB controller;
a sending module, configured to send a USB interrupt to the second USB controller to enable the baseboard management controller to trigger a log collection process according to the USB interrupt, and collecting log information into a shared memory, wherein the shared memory is used to store the log information fed back by the baseboard management controller and the embedded controller, and the external device reads the log information by the baseboard management controller.

On another aspect of the embodiments of the present disclosure, a server log collection apparatus is provided, including:
a receiving module, configured to receive a USB interrupt sent by an embedded controller by a second USB controller, wherein the USB interrupt is generated when the embedded controller determines that an external device accesses a server log collection system by a first USB controller, and the server log collection system includes an embedded controller and a baseboard management controller, the embedded controller and the baseboard management controller are in communication connection through a USB bus, wherein the embedded controller includes a first USB controller and the baseboard management controller includes a second USB controller;
a collection module, configured to is trigger a log collection process according to the USB interrupt, and collecting log information into a shared memory, wherein the shared memory is used to store the log information fed back by the baseboard management controller and the embedded controller, and the external device reads the log information by the baseboard management controller.

On another aspect of the embodiments of the present disclosure, a communication device is provided, including: a transceiver, a memory, a processor and a program stored in the memory and executable on the processor;
the processor, configured to read the program in the memory to implement the server log collection method according to any one of above.

On another aspect of the embodiments of the present disclosure, a non-transitory readable storage medium is provided for storing instructions, wherein the instructions, when executed by a processor, implements the server log collection method according to any one of above.

According to the server log collection method provided by some embodiments of the present disclosure, an external device is determined to access the server log collection system by a first USB controller, wherein the server log collection system includes an embedded controller and a baseboard management controller, and the embedded controller and the baseboard management controller are in communication connection through a USB bus, and the embedded controller includes a first USB controller and the baseboard management controller includes a second USB controller; Sending a USB interrupt to the second USB controller, so that the baseboard management controller triggers the log collection process according to the USB interrupt, and collects the log information into the shared memory, wherein the shared memory is used to store the log information fed back by the baseboard management controller and the embedded controller, and the external device reads the log information by the baseboard management controller. Some embodiments of the present disclosure realize intelligent log collection and transmission based on BMC +embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

### BRIEF DESCRIPTION OF THE DRAWINGS

In order to more clearly explain some embodiments of the present disclosure or the technical solution in the prior art, the drawings needed in the description of the embodiments or the prior art will be briefly introduced below.

FIG. 1 shows a flowchart of steps of a server log collection method provided by some embodiments of the present disclosure;

FIG. 2 shows a flowchart of steps of another server log collection method provided by some embodiments of the present disclosure;

FIG. 3 shows flowchart of step 205 in the flowchart of steps of another server log collection method provided by some embodiments of the present disclosure in FIG. 2;

FIG. 4 shows a flowchart of steps of another server log collection method provided by some embodiments of the present disclosure;

FIG. 5 shows a flowchart of steps of another server log collection method provided by some embodiments of the present disclosure;

FIG. 6 shows a schematic diagram of a server log collection system provided by some embodiments of the present disclosure;

FIG. 7 shows an apparatus block diagram of a server log collection apparatus provided by some embodiments of the present disclosure;

FIG. 8 shows an apparatus block diagram of another server log collection apparatus provided by some embodiments of the present disclosure;

FIG. 9 shows a structural block diagram of a communication device provided by some embodiments of the present disclosure.

### DETAILED DESCRIPTION

In the following, the technical solutions in some embodiments of the present disclosure will be described with reference to the drawings in some embodiments of the present disclosure.

In order to make the purpose, technical solution and advantages of some embodiments of the present disclosure clearer, the following will explain in detail the various embodiments of the present disclosure with the attached drawings. However, those skilled in the art can understand that in various embodiments of the present disclosure, many technical details are put forward in order to make readers better understand the present disclosure. However, even without these technical details and various changes and modifications based on the following embodiments, the technical solution claimed in the present disclosure can be realized. The following embodiments are divided for the convenience of description, and should not constitute any limitation on the specific implementation of the present disclosure. The embodiments can be combined with each other and cited without contradiction.

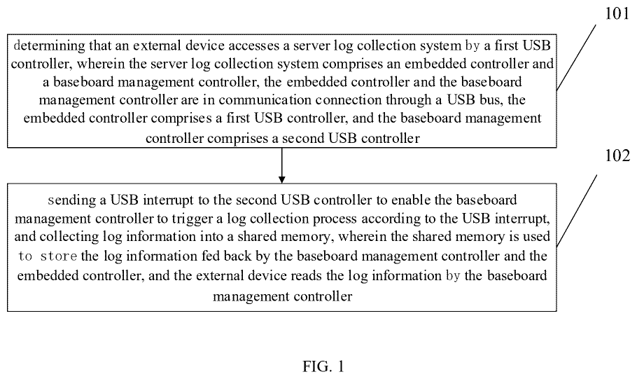

Referring to FIG. 1, a flowchart of steps of a server log collection method provided by some embodiments of the present disclosure is shown, and the method may include the following steps.

Step 101, determining that an external device accesses a server log collection system by a first USB controller, wherein the server log collection system comprises an embedded controller and a baseboard management controller, the embedded controller and the baseboard management controller are in communication connection through a USB bus, the embedded controller comprises a first USB controller, and the baseboard management controller comprises a second USB controller;

It should be noted that in some embodiments of the present disclosure, which are applied to an embedded controller, the present disclosure is based on the architecture of BMC (base board management controller)+embedded controller, and the architecture of BMC combined with AI (Artificial Intelligence) core embedded controller can release the occupation of BMC main core.

In the server, the baseboard management controller (BMC) is a component specially used for managing and monitoring the motherboard hardware, and the embedded controller can be MCU (Micro-controller Unit), CPLD (Complex Programmable Logic Device), DSP (Digital Signal Processor), ASIC (Application-Specific Integrated Circuit), FPGA (Field-Programmable Gate Array), etc. An embedded controller is a small controller, which is used to control peripheral devices or perform specific tasks. Because of the advantages of low power consumption and lightweight, the embedded controller can quickly detect peripheral changes. Therefore, when an external device, such as a USB (Type-C) device, is connected, the first USB controller included in the embedded controller will serve as a USB HOST (USB host), that is, at this time, the embedded controller has a master control over the external device and is in a master control state, to achieve automatically detect whether there is a newly connected external device.

The USB HOST means that the current device (embedded controller) can be used as a USB host to connect USB peripheral devices, such as USB flash drive, keyboard, mouse, etc., and its equivalent is a USB Device (translated as a target in some places), which means that the device can be connected to the USB host as a USB flash drive.

Specifically, the external device in the present disclosure can be a mobile phone with a type-c interface or a USB plug-in device, for example, a USB flash drive. In order to facilitate the understanding of those skilled in the art, the following description will take a mobile phone device with a Type-C interface as an example.

After the server is powered on normally, the Real-time operating system (RTOS) running on the embedded controller will be booted first, that is, the embedded controller will be booted earlier than the BMC. Therefore, when the Type-C interface is connected to the mobile phone device, the first USB controller of the embedded controller will get the control right first to detect the new USB device in real time.

Step 102: sending a USB interrupt to the second USB controller to enable the baseboard management controller to trigger a log collection process according to the USB interrupt, and collecting log information into a shared memory, wherein the shared memory is used to store the log information fed back by the baseboard management controller and the embedded controller, and the external device reads the log information by the baseboard management controller.

The first USB controller in the embedded controller will be used as the USB HOST to detect the access of external devices. After the external devices are connected, the USB SLAVE terminal (USB device terminal), that is, the second USB controller included in the BMC, will be informed by the USB interrupt, and the main core will be informed to perform interrupt processing.

It should be noted that in some embodiments of the present disclosure, the USB interrupt is an asynchronous communication mode, and the data transmission and control signal interaction between the device and the host are realized by the preset interrupt handler. In the Linux kernel, the processing of USB interrupt needs to go through multiple layers of protocol stacks, including the USB driver, USB core, USB controller and hardware devices, etc. Therefore, all layers of protocol stack need to be considered when realizing USB interrupt handler to ensure the reliable and stable communication between USB device and host.

Therefore, after the second USB controller in the BMC receives the USB interrupt, it will trigger the process in the BMC, that is, the log collection process, wherein the log information about the BMC is collected, and the log information of the BMC saves the running status of the system board and the attached devices, and the running status of the components can be viewed by the log.

Furthermore, the collected log information is no longer stored in the BMC, but stored in the shared memory, wherein the storage content in the shared memory is shared by the BMC and the embedded controller and can be read, and the external device can read the log information in the shared memory by the BMC.

According to the server log collection method provided by some embodiments of the present disclosure, an external device is determined to access the server log collection system by a first USB controller, wherein the server log collection system includes an embedded controller and a baseboard management controller, and the embedded controller and the baseboard management controller are in communication connection through a USB bus, and the embedded controller includes a first USB controller and the baseboard management controller includes a second USB controller; Sending a USB interrupt to the second USB controller, so that the baseboard management controller triggers the log collection process according to the USB interrupt, and collects the log information into the shared memory, wherein the shared memory is used to store the log information fed back by the baseboard management controller and the embedded controller, and the external device reads the log information by the baseboard management controller. Some embodiments of the present disclosure realize intelligent log collection and transmission based on BMC+embedded controller architecture. Compared with the prior art that only a single BMC is used to realize log collection and transmission, the communication mode between BMC and embedded controller in the present disclosure adopts an USB interface, which realizes data transmission and mutual transmission of control signals through the USB bus. The USB interface has the advantages of ease of use and reliability, and can also support high-speed data transmission and various types of device connections. Therefore, the communication between BMC and embedded controller by USB interface can improve the management efficiency and reliability of the server. Further, the present disclosure can greatly reduce the load of BMC and improve the transmission efficiency with external devices by introducing the embedded controller to determine external devices and subsequent storage and processing of log information. Therefore, in some embodiments of the present disclosure, the access of external devices is detected in real time by the embedded controller. The transmission rate has been greatly improved, and the BMC and embedded controller server have good compatibility and can be integrated with different types of servers, thus improving the scalability and flexibility of the server.

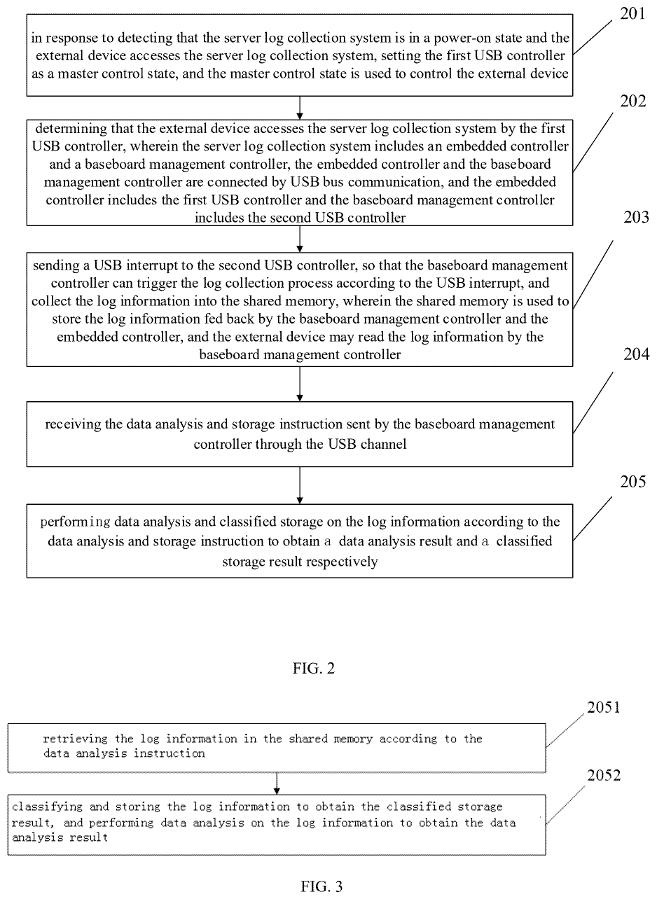

Referring to FIG. 2, a flowchart of steps of another server log collection method provided by some embodiments of the present disclosure is shown, and the method may include the following steps.

Step 201, in response to detecting that the server log collection system is in a power-on state and the external device accesses the server log collection system, setting the first USB controller as a master control state, and the master control state is used to control the external device.

It should be noted that in some embodiments of the present disclosure, both the embedded controller and the BMC include USB controllers, the former includes a first USB controller and the latter includes a second USB controller. The two USB controllers may switch control states according to the actual functions of the embedded controller and the BMC, wherein the control states include a master control state and a slave control state. When the first USB controller is in the master control state, the embedded controller can be used as a USB host to which an external USB device is connected, and control and determine the external device.

Step 202, determining that the external device accesses the server log collection system by the first USB controller, wherein the server log collection system includes an embedded controller and a baseboard management controller, the embedded controller and the baseboard management controller are connected by USB bus communication, and the embedded controller includes the first USB controller and the baseboard management controller includes the second USB controller;

Step 203, sending a USB interrupt to the second USB controller, so that the baseboard management controller can trigger the log collection process according to the USB interrupt, and collect the log information into the shared memory, wherein the shared memory is used to store the log information fed back by the baseboard management controller and the embedded controller, and the external device may read the log information by the baseboard management controller.

It should be noted that in some embodiments of the present disclosure, the above steps 202-203 are discussed with reference to the preceding discussion, and are not repeated here.

Step 204, receiving the data analysis and storage instruction sent by the baseboard management controller through the USB channel;

It should be noted that, in some embodiments of the present disclosure, after the BMC collects the log information and stores it in the shared memory, the BMC will notify the embedded controller by USB channel communication, and inform the embedded controller that the log information in the shared memory can be analyzed and processed. At this time, the BMC will no longer participate in the analysis and processing process of the log information.

Step 205, performing data analysis and classified storage on the log information according to the data analysis and storage instruction to obtain a data analysis result and a classified storage result respectively.

Therefore, the embedded controller performs data analysis and classified storage on the log information based on the work instructions sent by BMC, that is, data analysis and storage instructions, and obtains the data analysis result and the classified storage result respectively.

Further, as shown in FIG. 3, FIG. 3 shows a flowchart of step 205 in the flowchart of steps of another server log collection method provided by some embodiments of the present disclosure in FIG. 2, which may include the following steps 2051-2052:
step 2051, retrieving the log information in the shared memory according to the data analysis instruction;
step 2052, classifying and storing the log information to obtain the classified storage result, and performing data analysis on the log information to obtain the data analysis result.

Specifically, the data analysis process of the embedded controller retrieves the log data in the shared memory, classifies and stores the log data according to different algorithms, and analyzes the log information to ensure that there is no abnormal running data in the system.

Therefore, it can be divided into three algorithms for three types of processing, including a preset clustering analysis algorithm required for classified storage based on data types, a preset natural language processing algorithm required for classified storage based on the alarm levels in the log information, and an anomaly detection model required for detecting anomalies in the log information.

Further, classifying and storing the log information to obtain a classified storage result includes classifying and storing the log information based on a preset type by a preset clustering analysis algorithm to obtain a first classified storage result, wherein the preset type includes at least one of a component, a temperature, a central processing unit (CPU) and a memory.

For the first one, the preset clustering analysis algorithm required for classified storage based on data types, the clustering analysis algorithm is a multivariate statistical technique, mainly including hierarchical clustering method and iterative clustering method. Clustering analysis, also known as group analysis and point group analysis, is a multivariate statistical method to study classification. Logs in log information are classified and stored according to preset types such as components, temperature, CPU and memory, and similar patterns and abnormal patterns in data are identified, thus improving the efficiency and accuracy of log analysis.

In other embodiments of the present disclosure, classifying and storing the log information to obtain a classified storage result includes classifying and storing the log information based on the alarm level by a preset language processing algorithm to obtain a second classified storage result, wherein the alarm level includes a serious alarm and a non-serious alarm.

For the second type, the preset natural language processing algorithm required for classified storage based on the alarm levels in the log information, the natural language processing algorithm can realize effective communication between people and computers in natural language, and classify and store the alarm levels in the log information, wherein the alarm levels include serious alarms and non-serious alarms.

Performing data analysis on the log information, to obtain the data analysis result include: constructing an anomaly detection model for the log information by a preset anomaly detection algorithm; The abnormal log information is detected by the abnormal detection model, and the abnormal log information is obtained.

For the third type, the anomaly detection model required for detecting anomalies in the log information, a machine learning anomaly detection means machine learning according to common abnormal faults. By analyzing and learning the server log data, an anomaly detection model is established to identify abnormal behaviors and take timely measures. By deeply learning the log data, patterns, associations and laws in the data are automatically discovered, to improve the accuracy and efficiency of log analysis and make fault prediction.

It should be noted that the algorithm models required in the above three data analysis and storage methods are not specifically limited in the present disclosure, and can be selected according to the actual needs of user business scenarios.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

In addition, both BMC and embedded controller server have high reliability, which can provide remote management and monitoring in case of server failure, thus reducing the impact of server failure. The current status of the server can be quickly grasped by peripherals by the operation of log classification and prediction alarm storage to the mobile phone, which improves the reliability.

In addition, by applying artificial intelligence technology to the BMC and the embedded controller server, automatic management and monitoring can be realized, thus improving the intelligent level of the server. Clustering analysis, machine learning and other algorithms are used in log analysis to make the server update intelligent.

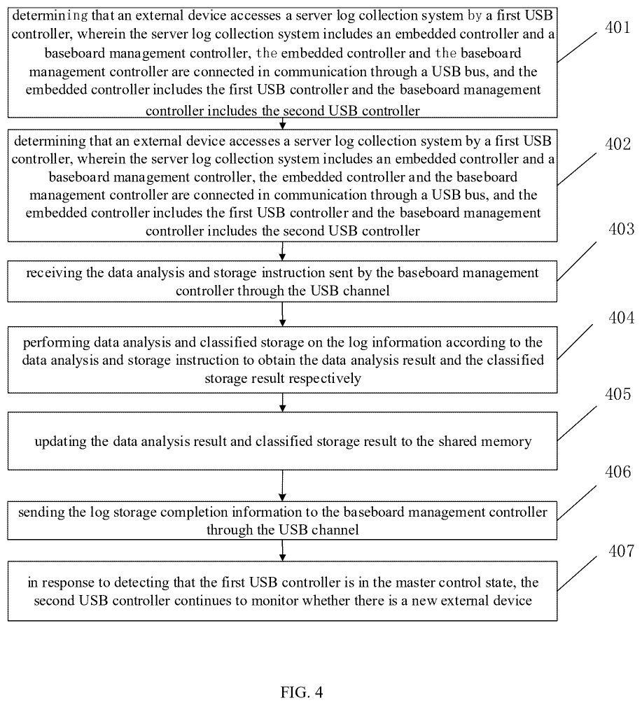

Referring to FIG. 4, a flowchart of steps of another server log collection method provided by some embodiments of the present disclosure is shown, and the method may include the following steps.

Step 401, determining that an external device accesses a server log collection system by a first USB controller, wherein the server log collection system includes an embedded controller and a baseboard management controller, the embedded controller and the baseboard management controller are connected in communication through a USB bus, and the embedded controller includes the first USB controller and the baseboard management controller includes the second USB controller;

Step 402, sending a USB interrupt to the second USB controller, so that the baseboard management controller can trigger the log collection process according to the USB interrupt, and collect the log information into the shared memory, wherein the shared memory is used to store the log information fed back by the baseboard management controller and the embedded controller, and the external device can read the log information by the baseboard management controller.

Step 403, receiving the data analysis and storage instruction sent by the baseboard management controller through the USB channel;

Step 404, performing data analysis and classified storage on the log information according to the data analysis and storage instruction to obtain the data analysis result and the classified storage result respectively.

It should be noted that in some embodiments of the present disclosure, the above steps 401-404 are discussed with reference to the preceding discussion, and are not repeated here.

Step 405, updating the data analysis result and classified storage result to the shared memory;

It should be noted that after the embedded controller analyzes and processes the data in the shared memory, the embedded controller will update the data analysis result and classified storage result to the shared memory.

Step 406, sending the log storage completion information to the baseboard management controller through the USB channel.

Furthermore, the BMC is informed that the log storage is completed through the USB channel. At this time, after receiving the log storage completion information sent by the embedded controller, the BMC will communicate and transmit the data required by the external device. Specifically, refer to other subsequent embodiments.

Step 407, in response to detecting that the first USB controller is in the master control state, the second USB controller continues to monitor whether there is a new external device.

After the data copy storage of the external device is completed, the BMC will release the master control of the second USB controller, that is, switch the control state. At this time, the embedded controller can be used as the USB HOST of the new external device again and continue to monitor the new external device.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

In addition, the BMC server can realize remote management and monitoring, remote control and diagnosis of the server, while the embedded controller server can realize low delay and efficient data processing. Therefore, data transmission and mutual transmission of control signals are realized through USB bus, that is, the embedded controller and BMC can control external devices in stages by switching the states of the first USB controller and the second USB controller to the master control state and the slave control state, which improves the response speed and processing capacity of the server.

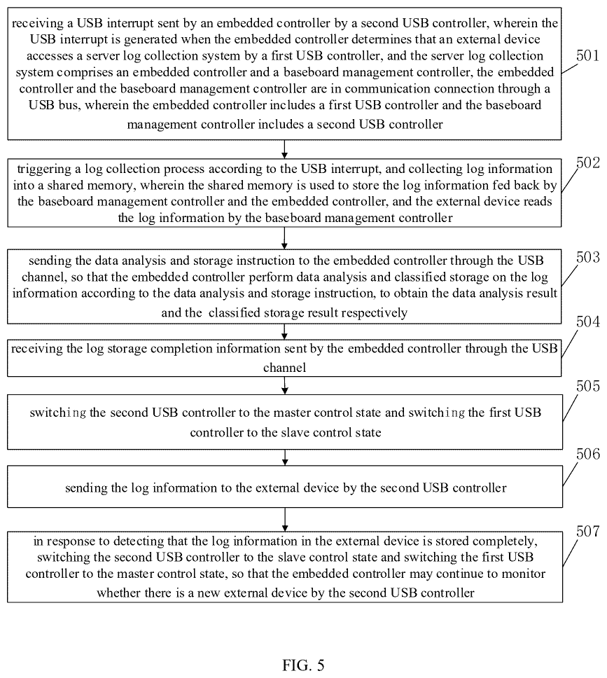

Referring to FIG. 5, a flowchart of steps of another server log collection method provided by some embodiments of the present disclosure is shown, and the method may include the following steps.

Step 501, receiving a USB interrupt sent by an embedded controller by a second USB controller, wherein the USB interrupt is generated when the embedded controller determines that an external device accesses a server log collection system by a first USB controller, and the server log collection system comprises an embedded controller and a baseboard management controller, the embedded controller and the baseboard management controller are in communication connection through a USB bus, wherein the embedded controller includes a first USB controller and the baseboard management controller includes a second USB controller;

It should be noted that in some embodiments of the present disclosure, the above step 501 is discussed with reference to the preceding discussion, and will not be repeated here.

Step 502, triggering a log collection process according to the USB interrupt, and collecting log information into a shared memory, wherein the shared memory is used to store the log information fed back by the baseboard management controller and the embedded controller, and the external device reads the log information by the baseboard management controller;

Further, triggering the log collection process according to the USB interrupt and collecting the log information into the shared memory includes: calling the preset interrupt handler in the embedded controller and clearing the USB interrupt flag bit; according to the USB interrupt flag bit, the log collection process is triggered, and the log information is collected into the shared memory.

It should be noted that the present disclosure is applied to the BMC, and for the BMC, triggering the log collection process by the USB interrupt means calling the preset interrupt handler in the embedded controller and clearing the USB interrupt flag bit; According to the USB interrupt flag bit, the log collection process is triggered, and the log information is collected into the shared memory.

Specifically, the USB interrupt handler in the kernel is called to clear the USB interrupt flag bit, and the embedded controller side can continue to monitor the access of new USB devices in real time, and the BMC side triggers the log collection process according to the interrupt to collect the logs to the shared memory.

Step 503, sending the data analysis and storage instruction to the embedded controller through the USB channel, so that the embedded controller perform data analysis and classified storage on the log information according to the data analysis and storage instruction, to obtain the data analysis result and the classified storage result respectively.

Step 504, receiving the log storage completion information sent by the embedded controller through the USB channel;

It should be noted that in some embodiments of the present disclosure, the above steps 503-504 are discussed with reference to the preceding discussion, and are not repeated here.

Step 505, switching the second USB controller to the master control state and switching the first USB controller to the slave control state;

Step 506, sending the log information to the external device by the second USB controller.

It should be noted that in some embodiments of the present disclosure, after receiving the notification, the BMC switches the second USB controller to the Master, that is, the master control state, and then the first USB controller in the corresponding embedded controller is switched to the slave control state at this time. Because the type of data transmission requires higher CPU frequency, the data transmission is handed over to the BMC to realize direct communication with external devices, such as Type-C storage devices.

Furthermore, the BMC copies the classified logs and fault prediction results in the shared memory to the Type-C mobile phone device.

Further, step 506 includes copying the data analysis result and the classified storage result to the external device by the second USB controller.

It should be noted that in addition to the above methods, some embodiments of the present disclosure can also transmit data required by other external devices to external devices by the above methods.

Step 507, in response to detecting that the log information in the external device is stored completely, switching the second USB controller to the slave control state and switching the first USB controller to the master control state, so that the embedded controller may continue to monitor whether there is a new external device by the second USB controller.

It should be noted that in some embodiments of the present disclosure, after the storage is completed, the BMC releases the Master control right of the second USB controller, that is, switches to the slave control state again, so that the embedded controller can continue to monitor the new USB device.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

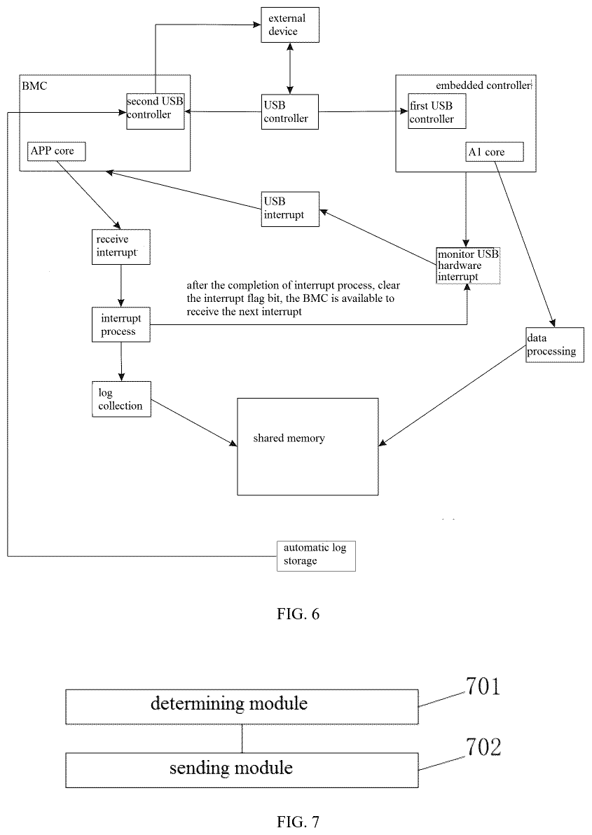

Referring to FIG. 6, FIG. 6 shows a server log collection system provided by some embodiments of the present disclosure. The server log collection system includes an embedded controller, a baseboard management controller and a shared memory, the embedded controller and the baseboard management controller are in communication connection through a USB bus;
the embedded controller comprises a first USB controller, and the baseboard management controller comprises a second USB controller;
the first USB controller is used to determine that an external device accesses to the server log collection system;
the second USB controller is used to receive the USB interrupt sent by the first USB controller, trigger a log collection process according to the USB interrupt, and collect the log information into the shared memory; and
the external device reads the log information by the shared memory.

It should be noted that after an external device is connected, the first USB controller of the embedded controller will be used as a USB HOST terminal to detect the access of new devices, and the USB SLAVE terminal, that is, the second USB controller of BMC, will inform the main core by the USB interrupt to perform the interrupt process, and the embedded controller will be informed to monitor the insertion and removal of new devices after the interrupt process is completed. After the BMC receives the interrupt, the interrupt flag bit will be cleared, and then the data collection process will be triggered. After data collection is completed, the data will be transmitted to the shared memory, and the embedded controller will be notified by USB channel communication. The embedded controller will retrieve the shared memory data for intelligent algorithm processing, and perform clustering analysis, natural language processing and machine learning anomaly detection on the log data. The data processing process of the embedded controller will store the processed log information and results in the shared memory, and notify the BMC by USB channel communication. The log collection process on the BMC collects data from the shared memory according to the notification information and automatically stores the data to the storage partition of the external device. The overall architecture diagram is shown in FIG. 6.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

Referring to FIG. 7, FIG. 7 shows a server log collection apparatus provided by some embodiments of the present disclosure, and the apparatus includes:
a determining module 701, configured to determine that an external device accesses a server log collection system by a first USB controller, wherein the server log collection system comprises an embedded controller and a baseboard management controller, the embedded controller and the baseboard management controller are in communication connection through a USB bus, the embedded controller comprises a first USB controller, and the baseboard management controller comprises a second USB controller;
a sending module 702, configured to send a USB interrupt to the second USB controller to enable the baseboard management controller to trigger a log collection process according to the USB interrupt, and collecting log information into a shared memory, wherein the shared memory is used to store the log information fed back by the baseboard management controller and the embedded controller, and the external device reads the log information by the baseboard management controller.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

Referring to FIG. 8, FIG. 8 shows a server log collection apparatus provided by some embodiments of the present disclosure, and the apparatus includes:
a receiving module 801, configured to receive a USB interrupt sent by an embedded controller by a second USB controller, wherein the USB interrupt is generated when the embedded controller determines that an external device accesses a server log collection system by a first USB controller, and the server log collection system comprises an embedded controller and a baseboard management controller, the embedded controller and the baseboard management controller are in communication connection through a USB bus, wherein the embedded controller comprises a first USB controller and the baseboard management controller comprises a second USB controller;
a collection module 802, configured to is trigger a log collection process according to the USB interrupt, and collecting log information into a shared memory, wherein the shared memory is used to store the log information fed back by the baseboard management controller and the embedded controller, and the external device reads the log information by the baseboard management controller.

Some embodiments of the present disclosure realize intelligent log collection and transmission based on BMC+embedded controller architecture. Compared with the prior art that only a single BMC is used to realize log collection and transmission, the communication mode between the BMC and the embedded controller in the present disclosure adopts a USB interface, which realizes data transmission and mutual transmission of control signals through USB bus. The USB interface has the advantages of ease of use and reliability, and can also support high-speed data transmission and various types of device connections. Therefore, the communication between the BMC and the embedded controller by the USB interface can improve the management efficiency and reliability of the server. Further, the present disclosure can greatly reduce the load of BMC and improve the transmission efficiency with external devices by introducing the embedded controller to determine external devices and subsequent storage and processing of the log information. Therefore, in some embodiments of the present disclosure, the access of external devices is detected in real time by the embedded controller. The transmission rate has been greatly improved, and BMC and embedded controller server have good compatibility and can be integrated with different types of servers, thus improving the scalability and flexibility of the server.

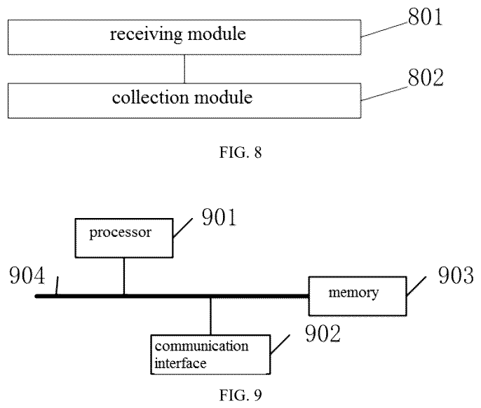

Some embodiment of that application also provide a communication device, as shown in FIG. 9, which includes a processor 901, a communication interface 902, a memory 903 and a communication bus 904, wherein the processor 901, the communication interface 902 and the memory 903 communicate with each other through a communication bus 904,
the memory 903, configured to store computer programs;
the processor 901, configured to execute the program stored in the memory 903, the following steps can be implemented:
determining that an external device accesses a server log collection system by a first USB controller, wherein the server log collection system includes an embedded controller and a baseboard management controller, and the embedded controller and the baseboard management controller are in communication connection through a USB bus, and the embedded controller includes a first USB controller and the baseboard management controller includes a second USB controller;
sending a USB interrupt to the second USB controller, so that the baseboard management controller triggers the log collection process according to the USB interrupt, and collects the log information into the shared memory, wherein the shared memory is used to store the log information fed back by the baseboard management controller and the embedded controller, and the external device reads the log information by the baseboard management controller.

The communication bus mentioned in the terminal can be a peripheral component interconnect (PCI) bus or an extended industry standard architecture (EISA) bus. The communication bus can be divided into address bus, data bus and control bus. For the convenience of representation, the figure is only represented by a thick line, but it does not mean that there is only one bus or one type of bus.

The communication interface is used for communication between the terminal and other devices.

The memory may include Random Access Memory (RAM) or non-volatile memory, such as at least one disk memory. Alternatively, the memory can also be at least one storage device located far away from the aforementioned processor.

The processor can be a general processor, including a Central Processing Unit (CPU), a Network Processor (NP), etc. It can also be a Digital Signal Processing (DSP), an application specific integrated circuit (ASIC), a Field-Programmable Gate Array (FPGA) or other programmable logic devices, discrete gate or transistor logic devices, and discrete hardware components.

In yet another embodiment provided by the present disclosure, there is also provided a non-transitory readable storage medium having stored therein instructions which, when run on a computer, cause the computer to perform log collection in any of the above embodiments.

In yet another embodiment provided by the present disclosure, there is also provided a computer program product containing instructions which, when run on a computer, cause the computer to perform the log collection described in any of the above embodiments.

In the above embodiments, it can be realized in whole or in part by software, hardware, firmware or any combination thereof. When implemented in software, it can be fully or partially implemented in the form of a computer program product. The computer program product includes one or more computer instructions. When the computer program instructions are loaded and executed on a computer, the processes or functions described in some embodiments of the present application are generated in whole or in part. The computer can be a general-purpose computer, a special-purpose computer, a computer network, or other programmable devices. The computer instructions can be stored in a nonvolatile readable storage medium or transmitted from one nonvolatile readable storage medium to another. For example, the computer instructions can be transmitted from a website, a computer, a server or a third database to another website, via wired (such as coaxial cable, optical fiber, digital subscriber line (DSL)) or wireless (such as infrared, wireless, microwave, etc.). The non-volatile readable storage medium can be any available medium that a computer can access, or a data storage device such as a server or a third database that contains one or more available media integration. The usable medium may be a magnetic medium (e.g., floppy disk, hard disk, magnetic tape), an optical medium (e.g., DVD), or a semiconductor medium (e.g., Solid State Disk (SSD)) and the like.

It should be noted that in this paper, relational terms such as first and first are only used to distinguish one entity or operation from another entity or operation, and do not necessarily require or imply that there is any such actual relationship or order between these entities or operations. Moreover, the terms “including”, “containing” or any other variation thereof are intended to cover non-exclusive inclusion, so that a process, method, article or equipment including a series of elements includes not only those elements, but also other elements not explicitly listed or elements inherent to such process, method, article or equipment. Without further restrictions, an element defined by the phrase “including one” does not exclude the existence of other identical elements in the process, method, article or equipment including the element.

Each embodiment in this specification is described in a related way, and only the same and similar parts between the embodiments can be referred to each other, and each embodiment focuses on the differences from other embodiments. Especially, for the system embodiment, because it is basically similar to the method embodiment, the description is relatively simple, and the relevant points can only be found in part of the description of the method embodiment.

The above is only the preferred embodiments of the present disclosure, and is not used to limit the protection scope of the present disclosure. Any modification, equivalent substitution, improvement, etc. made within the spirit and principles of the present disclosure are included in the protection scope of the present disclosure.

1. A server log collection method, applied to an embedded controller, comprising:
determining that an external device accesses a server log collection system by a first USB controller, wherein the server log collection system comprises an embedded controller and a baseboard management controller, the embedded controller and the baseboard management controller are in communication connection through a USB bus, the embedded controller comprises a first USB controller, and the baseboard management controller comprises a second USB controller;
sending a USB interrupt to the second USB controller to enable the baseboard management controller to trigger a log collection process according to the USB interrupt, and collecting log information into a shared memory, wherein the shared memory is used to store the log information fed back by the baseboard management controller and the embedded controller, and the external device reads the log information by the baseboard management controller.

2. The server log collection method according to claim 1, wherein before a step of determining that the external device accesses the server log collection system by the first USB controller, the method comprises:
in response to detecting that the server log collection system is in a power-on state and the external device accesses the server log collection system, setting the first USB controller as a master control state, and the master control state is used to control the external device.

3. The server log collection method according to claim 1, wherein after a step of sending the USB interrupt to the second USB controller to enable the baseboard management controller to triggers the log collection process according to the USB interrupt and collecting the log information into the shared memory, the method comprises:
receiving a data analysis and storage instruction sent by the baseboard management controller through a USB channel;
performing data analysis and classified storage on the log information according to the data analysis and storage instruction, and respectively obtaining a data analysis result and a classified storage result.

4. The server log collection method according to claim 3, wherein performing data analysis and classified storage on the log information according to the data analysis and storage instruction to obtain the data analysis result and the classified storage result respectively comprises:
retrieving the log information in the shared memory according to the data analysis instruction;
classifying and storing the log information to obtain the classified storage result, and
performing data analysis on the log information to obtain the data analysis result.

5. The server log collection method according to claim 4, wherein classifying and storing the log information to obtain the classified storage result comprises:
classifying and storing the log information based on a preset type by a preset clustering analysis algorithm to obtain a first classified storage result, wherein the preset type comprises at least one of component, temperature, CPU and memory.

6. The server log collection method according to claim 4, wherein classifying and storing the log information to obtain the classified storage result comprises:
classifying and storing the log information based on alarm levels by a preset language processing algorithm to obtain a second classified storage result, wherein the alarm levels comprise a serious alarm and a non-serious alarm.

7. The server log collection method according to claim 4, wherein performing data analysis on the log information to obtain the data analysis result comprises:
constructing an anomaly detection model for the log information by a preset anomaly detection algorithm;
performing anomaly information detection on the log information by the anomaly detection model to obtain anomaly log information.

8. The server log collection method according to claim 3, wherein after a step of performing data analysis and classified storage on the log information according to the data analysis and storage instruction to obtain a data analysis result and a classified storage result respectively, the method comprises:
updating the data analysis result and the classified storage result to the shared memory;
sending log storage completion information to the baseboard management controller through the USB channel.

9. The server log collection method according to claim 8, wherein after a step of sending the log storage completion information to the baseboard management controller through the USB channel, the method comprises:
in response to detecting that the first USB controller is in the master control state, continuing to monitor whether there is a new external device by the second USB controller.

10. A server log collection method, applied to a baseboard management controller, comprising:
receiving a USB interrupt sent by an embedded controller by a second USB controller, wherein the USB interrupt is generated when the embedded controller determines that an external device accesses a server log collection system by a first USB controller, and the server log collection system comprises an embedded controller and a baseboard management controller, the embedded controller and the baseboard management controller are in communication connection through a USB bus, wherein the embedded controller comprises a first USB controller and the baseboard management controller comprises a second USB controller;
triggering a log collection process according to the USB interrupt, and collecting log information into a shared memory, wherein the shared memory is used to store the log information fed back by the baseboard management controller and the embedded controller, and the external device reads the log information by the baseboard management controller.

11. The server log collection method according to claim 10, wherein triggering the log collection process according to the USB interrupt and collecting the log information into the shared memory comprises:
calling a preset interrupt handler in the embedded controller and clearing a USB interrupt flag bit;
triggering the log collection process according to the USB interrupt flag bit, and collecting the log information into the shared memory.

12. The server log collection method according to claim 10, wherein after a step of triggering the log collection process according to the USB interrupt and collecting the log information into the shared memory, the method further comprises:
sending a data analysis and storage instruction to the embedded controller through a USB channel, so that the embedded controller performs data analysis and classified storage on the log information according to the data analysis and storage instruction, and obtains a data analysis result and a classified storage result respectively.

13. The server log collection method according to claim 12, wherein after a step of sending a data analysis and storage instruction to the embedded controller through a USB channel, so that the embedded controller performs data analysis and classified storage on the log information according to the data analysis and storage instruction, and obtains a data analysis result and a classified storage result respectively, the method comprises:
receiving log storage completion information sent by the embedded controller through the USB channel;
switching the second USB controller to a master control state and switching the first USB controller to a slave control state;
sending the log information to the external device by the second USB controller.

14. The server log collection method according to claim 13, wherein sending the log information to the external device by the second USB controller comprises:
copying the data analysis result and the classified storage result to the external device by the second USB controller.

15. The server log collection method according to claim 13, wherein after a step of sending the log information to the external device by the second USB controller, the method comprises:
in response to detecting that storage of the log information in the external device is completed, switching the second USB controller to the slave control state, and switching the first USB controller is to the master control state, so that the embedded controller continues to monitor whether there is a new external device by the second USB controller.

16. A server log collection system, wherein the server log collection system comprises an embedded controller, a baseboard management controller and a shared memory, the embedded controller and the baseboard management controller are in communication connection through a USB bus;
the embedded controller comprises a first USB controller, and the baseboard management controller comprises a second USB controller;
the first USB controller is used to determine that an external device accesses to the server log collection system;
the second USB controller is used to receive the USB interrupt sent by the first USB controller, trigger a log collection process according to the USB interrupt, and collect the log information into the shared memory; and
the external device reads the log information by the shared memory.

17. (canceled)

18. (canceled)

19. A communication device comprising: a transceiver, a memory, a processor and a program stored in the memory and executable on the processor;
the processor, configured to read the program in the memory to implement the server log collection method according to claim 1.

20. A non-transitory readable storage medium for storing a program, wherein the program, when executed by a processor, implements the server log collection method according to claim 1.

21. The server log collection method according to claim 4, wherein the data analysis process of the embedded controller retrieves the log data in the shared memory, classifies and stores the log data according to different algorithms, and analyzes the log information to ensure that there is no abnormal running data in the system.

22. The server log collection method according to claim 21, wherein the algorithms comprises a preset clustering analysis algorithm required for classified storage based on data types, a preset natural language processing algorithm required for classified storage based on the alarm levels in the log information, and an anomaly detection model required for detecting anomalies in the log information.
